(19) United States
(12) Patent Application Publication
(10) Pub. No.: US 2019/0232688 A1
(43) Pub. Date: Aug. 1, 2019

(54) PRINTING APPARATUS FOR WEB PRINT MEDIUM

(71) Applicant: RISO KAGAKU CORPORATION, Tokyo (JP)

(72) Inventor: Hideaki OGAWA, Ibaraki (JP)

(73) Assignee: RISO KAGAKU CORPORATION, Tokyo (JP)

(21) Appl. No.: 16/256,691

(22) Filed: Jan. 24, 2019

(30) Foreign Application Priority Data
Jan. 29, 2018 (JP) 2018-012588

(51) Int. Cl. B41J 11/46; B41J 13/00; B41J 15/04

(52) U.S. Cl. CPC B41J 11/46; B41J 2/01; B41J 15/048; B41J 13/0009

(57) ABSTRACT

A printing apparatus includes: a conveyor configured to convey a web print medium with holes arranged at a predetermined pitch in a conveyance direction; a printer configured to perform printing on the web print medium conveyed by the conveyor; a detector configured to detect the holes; and a controller. The controller is configured to drive the printer to start printing on the web print medium based on a timing at which a count value of the holes detected by the detector from start of conveyance of the web print medium by the conveyor reaches a setting value of a number of the holes located from the detector to a print start reference position on the web print medium at the start of conveyance of the web print medium by the conveyor.

### CROSS REFERENCE TO RELATED APPLICATION

This application is based upon and claims the benefit of priority from the prior Japanese Patent Application No. 2018-012588, filed on Jan. 29, 2018, the entire contents of which are incorporated herein by reference.

### BACKGROUND

### 1. TECHNICAL FIELD

The disclosure relates to a printing apparatus configured to perform printing while conveying a web print medium.

### 2. RELATED ART

Japanese Patent Application Publication No. 2013-169706 proposes a printing apparatus configured to perform printing on a continuous sheet in which aligned holes called sprocket holes are formed in side end portions. The printing apparatus forms images in regions for the respective pages divided by perforations of the continuous sheet while conveying the continuous sheet with protrusions of a tractor engaging with the holes.

Moreover, printing on a continuous sheet with holes is sometimes performed in a printing apparatus including no mechanism such as the tractor which is dedicated to conveyance of the aforementioned continuous sheet with holes.

For example, a printing apparatus configured to perform printing on a long web print medium while pulling out and conveying the print medium from a roll of the wound print medium by using tension sometimes performs printing by using, as the print medium, a web continuous sheet in which holes aligned in the conveyance direction are formed.

### SUMMARY

When the printing apparatus configured to perform printing while pulling out and conveying a web print medium from a roll by using tension performs printing by using a continuous sheet with holes as the print medium as described above, the position of the perforation at the border between pages needs to be set as a reference of the print start position to perform. printing in regions for the respective pages in the continuous sheet.

The printing can be started with a desired perforation set as the reference by, for example, arranging the desired perforation at a predetermined position before the start of conveyance of the continuous sheet for the printing.

However, particularly in a printing apparatus configured to perform printing while pulling out a continuous sheet from a large roll, when a user tries to send and stop the continuous sheet to arrange the desired perforation at the predetermined position, it is difficult to accurately stop the perforation at the predetermined position due to inertia of the roll and the like. Accordingly, it is difficult to start the printing from the desired position on the continuous sheet.

The disclosure is directed to a printing apparatus which can start printing on a web print medium from a desired position, the web print medium having holes formed aligned in a conveyance direction.

A printing apparatus in accordance with some embodiments includes: a conveyor configured to convey a web print medium with holes arranged at a predetermined pitch in a conveyance direction; a printer configured to perform printing on the web print medium conveyed by the conveyor; a detector configured to detect the holes; and a controller. The controller is configured to drive the printer to start printing on the web print medium based on a timing at which a count value of the holes detected by the detector from start of conveyance of the web print medium by the conveyor reaches a setting value of a number of the holes located from the detector to a print start reference position on the web print medium at the start of conveyance of the web print medium by the conveyor.

In the aforementioned configuration, the printing can be started from a desired position on the web print medium having the holes formed aligned in the conveyance direction.

### BRIEF DESCRIPTION OF DRAWINGS

FIG. 1 is a schematic configuration diagram of a print system including a printing apparatus according to an embodiment.

FIG. 2 is a plan view of a printer in the printing apparatus.

FIG. 3 is a control block diagram of the print system illustrated in FIG. 1.

FIG. 4 is a plan view of a continuous sheet with holes.

FIG. 5 is an explanatory view of a print start reference position.

FIG. 6 is a flowchart for explaining a print operation on the continuous sheet with holes.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

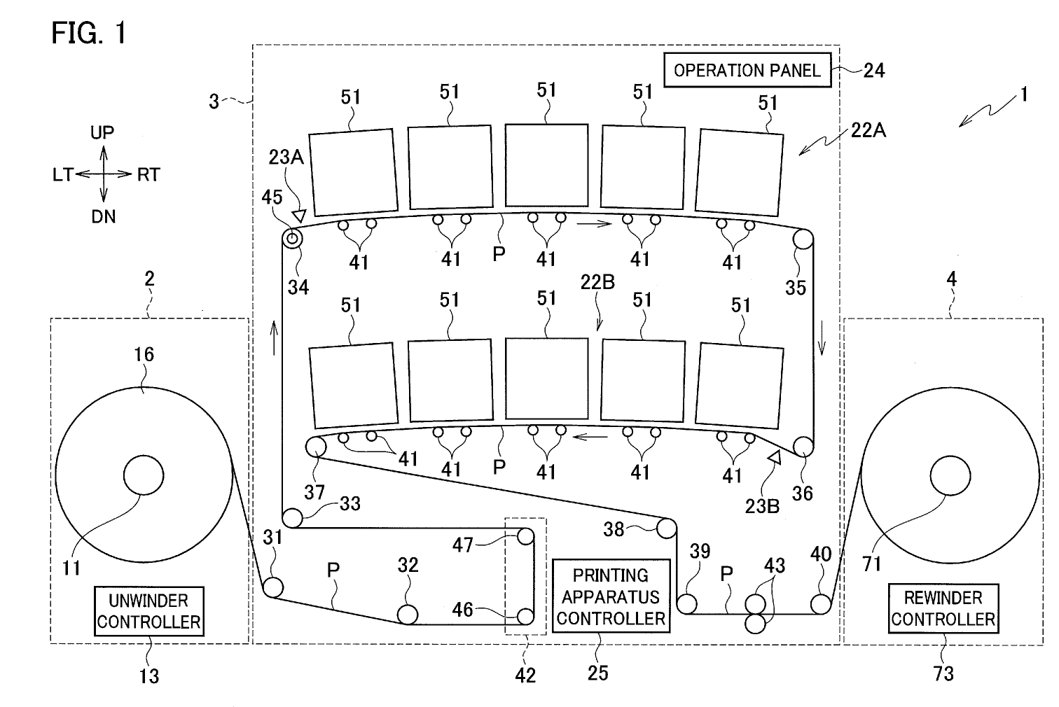

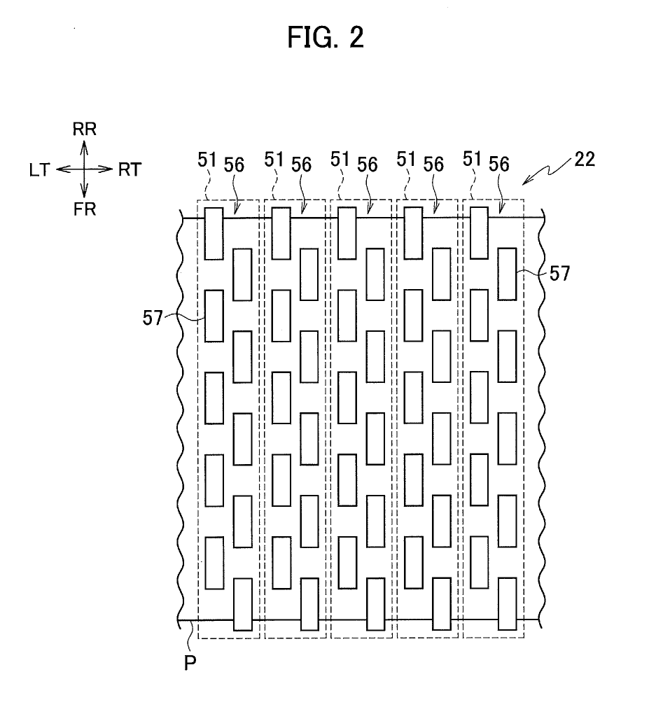

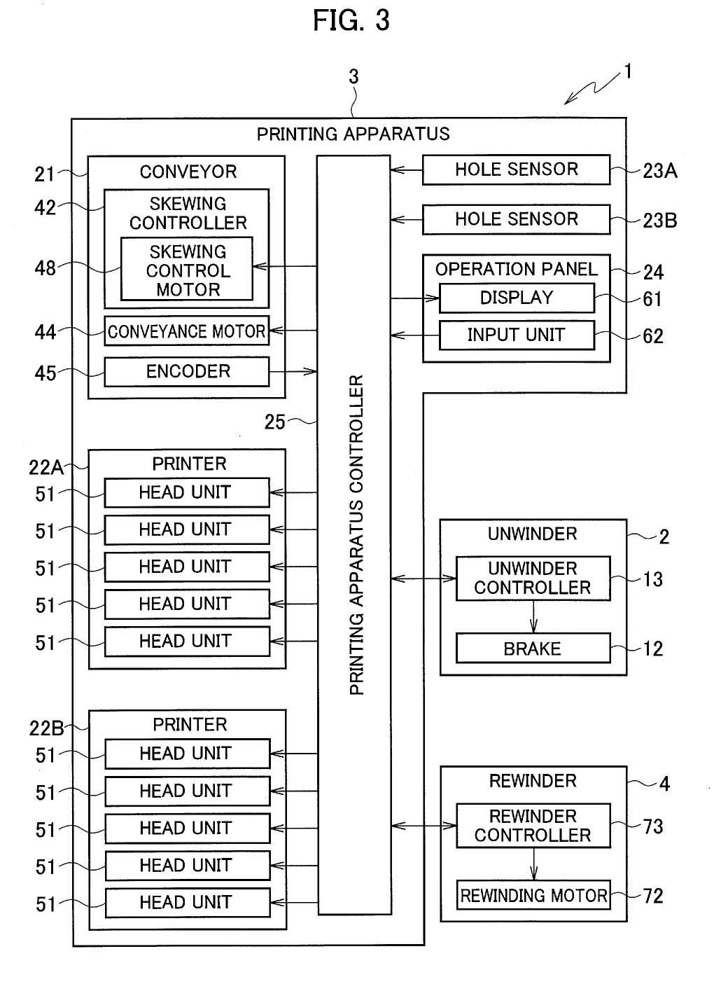

FIG. 1 is a schematic configuration diagram of a print system including a printing apparatus according to an embodiment of the present invention. FIG. 2 is a plan view of a printer in the printing apparatus. FIG. 3 is a control block diagram of the print system illustrated in FIG. 1. In the following description, a direction orthogonal to the sheet surface of FIG. 1 is referred to as front-rear direction and a direction from the sheet surface toward the viewer is referred to as forward. Moreover, up, down, left, and right in the sheet surface of FIG. 1 are referred to as upward, downward, leftward, and rightward directions. In FIGS. 1, 2, 4, and 5, the rightward direction, the leftward direction, the upward direction, the downward direction, the forward direction, the rearward direction, a width direction, and a conveyance direction are denoted by RT, LT, UP, DN, FR, RR, WD, and TD, respectively.

As illustrated in FIGS. 1 and 3, a print system 1 according to the embodiment includes an unwinder 2, a printing apparatus 3, and a rewinder 4.

The unwinder 2 unwinds a long web print medium P to the printing apparatus 3. The unwinder 2 includes a medium roll support shaft 11, a brake 12, and an unwinder controller 13.

The medium roll support shaft 11 rotatably supports a medium roll 16. The medium roll 16 is the print medium P wound into a roll.

The brake 12 act on the medium roll support shaft 11. Tension is thereby applied to the print medium P between the medium roll 16 and a pair of conveyance rollers 43 of the printing apparatus 3 to be described later.

The unwinder controller 13 controls the brake 12. The unwinder controller 13 includes a CPU, a RAM, a ROM, a hard disk drive, and the like.

The printing apparatus 3 prints an image on the print medium P while conveying the print medium P unwound from the medium roll 16. The printing apparatus 3 includes a conveyor 21, printers 22A, 22B, hole sensors (detectors) 23A, 23B, an operation panel 24, and a printing apparatus controller (controller) 25. Note that the printers 22A, 22B and the like may be collectively referred to by omitting the alphabets attached to the reference numerals.

The conveyor 21 conveys the print medium P while pulling it out from the medium roll 16. The conveyor 21 includes guide rollers 31 to 40, 20 under-head rollers 41, a skewing controller 42, the pair of conveyance rollers 43, a conveyance motor 44, and an encoder 45.

The guide rollers 31 to 40 guide the print medium P conveyed in the printing apparatus 3. The guide rollers 31 to 40 rotate by following the conveyed print medium P. The guide rollers 31 to 40, the under-head rollers 41, the conveyance rollers 43 and skewing control rollers 46, 47 of the skewing controller 42 to be described later form a conveyance route of the print medium P in the printing apparatus 3.

The guide rollers 31, 32 guide the print medium P between the unwinder 2 and the skewing controller 42. The guide roller 31 is arranged in a left end portion of a lower portion of the printing apparatus 3. The guide roller 32 is arranged between the guide roller 31 and the skewing control roller 46 of the skewing controller 42 to be described later.

The guide rollers 33 to 39 guide the print medium P between the skewing controller 42 and the pair of conveyance rollers 43. The guide roller 33 is arranged slightly above and on the left side of the skewing control roller 47 in the skewing controller 42 to be described later. The guide roller 34 is arranged above the guide roller 33. The guide roller 35 is arranged on the right side of the guide roller 34 at substantially the same height as the guide roller 34. The guide roller 36 is arranged below the guide roller 35 and above the guide roller 33. The guide roller 37 is on the left side of the guide roller 36, near and on the right side of the print medium P between the guide rollers 33, 34, at substantially the same height as the guide roller 36. The guide roller 38 is arranged on the lower right side of the guide roller 37. The guide roller 39 is arranged below and slightly on the right side of the guide roller 38.

The guide roller 40 guides the print medium P between the pair of conveyance rollers 43 and the rewinder 4. The guide roller 40 is arranged in a right end portion of a lower portion of the printing apparatus 3.

The under-head rollers 41 support the print medium P under head units 51 to be described later in an area between the guide rollers 34, 35 and an area between the guide rollers 36, 37. Ten under-head rollers 41 are arranged in each of the area between the guide rollers 34, 35 and the area between the guide rollers 36, 37. Moreover, two under-head rollers 41 are arranged directly below each head unit 51. The under-head rollers 41 rotate by following the conveyed print medium P.

The skewing controller 42 corrects skewing which is fluctuation in the position of the print medium P in the width direction (front-rear direction) orthogonal to the conveyance direction of the print medium P. The skewing controller 42 includes the skewing control rollers 46, 47 and a skewing control motor 48.

The skewing control rollers 46, 47 are rollers for guiding the print medium P and correcting the skewing of the print medium P. The skewing control rollers 46, 47 rotate by following the conveyed print medium P. The skewing control rollers 46, 47 move the print medium P in the width direction and correct the skewing by being turned to be tilted with respect to the width direction of the print medium P as viewed in the left-right direction. The skewing control roller 46 is arranged on the right side of the guide roller 32. The skewing control roller 47 is arranged above the skewing control roller 46.

The skewing control motor 48 turns the skewing control rollers 46, 47 about a turning axis parallel to the left-right direction.

The pair of conveyance rollers 43 conveys the print medium P toward the rewinder 4 while pulling the print medium P out from the medium roll 16. The pair of conveyance rollers 43 is arranged between the guide rollers 39, 40.

The conveyance motor 44 rotationally drives the conveyance rollers 43.

The encoder 45 is connected to the guide roller 34 and outputs a pulse signal every time the guide roller 34 rotates by a predetermined angle.

The printers 22A, 22B perform printing respectively on a front side and a back side of the print medium P. The printer 22A is arranged above and near the print medium P between the guide rollers 34, 35. The printer 22B is arranged above and near the print medium P between the guide rollers 36, 37. Each of the printers 22A, 22B includes five head units 51.

Each of the head units 51 includes an inkjet head 56. The inkjet head 56 prints images on the conveyed print medium P by ejecting an ink to the print medium P. In each of the printers 22, the inkjet heads 56 in the five head units 51 eject inks of different colors, respectively. Each inkjet head 56 includes multiple head modules 57. In the embodiment, as illustrated in FIG. 2, each inkjet head 56 includes ten head modules 57.

Each of the head modules 57 includes a nozzle row formed of multiple nozzles (not illustrated) arranged in the front-rear direction (main scanning direction) and ejects the ink from the nozzles. In each inkjet head 56, the ten head modules 57 are arranged in zigzag in the front-rear direction. Specifically, the ten head modules 57 are arranged in the front-rear direction with the positions thereof in the conveyance direction of the print medium P (left-right direction) alternately shifted.

The hole sensors 23A, 23B detect holes 76 when a continuous sheet SP with holes to be described later is used as the print medium P. The hole sensor 23A is arranged at a predetermined position near and upstream (on the left side) of the most-upstream (leftmost) head unit 51 in the printer 22A in the conveyance direction of the print medium P. The hole sensor 23B is arranged at a predetermined position near and upstream (on the right side) of the most-upstream (rightmost) head unit 51 in the printer 22B. The positions of the hole sensors 23 in the front-rear direction are such positions that the hole sensors 23 can detect front holes 76 or rear holes 76 of the continuous sheet SP. The hole sensors 23 are formed of optical sensors including light emitters and light receivers.

The operation panel 24 displays various input screens and the like and receives input operations performed by a user. The operation panel 24 includes a display 61 and an input unit 62.

The display 61 displays images of the various input screens and the like. The display 61 includes a liquid crystal display panel and the like.

The input unit 62 receives the input operations performed by the user and outputs operation signals depending on the operations. The input unit 62 includes various operation keys, touch panels, and the like.

The printing apparatus controller 25 controls operations of various units of the printing apparatus 3. The printing apparatus controller 25 includes a CPU, a RAM, a ROM, a hard disk drive, and the like.

When the continuous sheet SP with holes to be described later is used as the print medium P, the printing apparatus controller 25 sets the number of the holes 76 in an area from the hole sensor 23A to a print start reference position on the continuous sheet SP at start of conveyance of the continuous sheet SP as a setting value Cfs for the front side. The setting value Cfs is used to determine timing of starting the printing by the printer 22A. The setting value Cfs is inputted by a user operation. The printing apparatus controller 25 causes the printer 22A to start printing on the front side of the continuous sheet SP based on timing at which a count value Cfn of the holes 76 detected by the hole sensor 23A from the start of conveyance of the continuous sheet SP by the conveyor 21 reaches the setting value Cfs for the front side.

Moreover, when the continuous sheet SP is used as the print medium P, the printing apparatus controller 25 sets the number of the holes 76 in an area from the hole sensor 23B to the print start reference position on the continuous sheet SP at the start of conveyance of the continuous sheet SP as a setting value Crs for the back side. The setting value Crs is used to determine timing of starting the printing by the printer 22B. The setting value Crs is inputted by a user operation like the aforementioned setting value Cfs for the front side. The printing apparatus controller 25 causes the printer 22B to start printing on the back side of the continuous sheet SP based on timing at which a count value Crn of the holes 76 detected by the hole sensor 23B from the start of conveyance of the continuous sheet SP by the conveyor 21 reaches the setting value Crs for the back side.

The rewinder 4 rewinds the print medium P subjected to printing in the printing apparatus 3. The rewinder 4 includes a rewinding shaft 71, a rewinding motor 72, and a rewinder controller 73.

The rewinding shaft 71 rewinds and holds the print medium P.

The rewinding motor 72 rotates the rewinding shaft 71 clockwise in FIG. 1. Rotation of the rewinding shaft 71 causes the print medium P to be rewound on the rewinding shaft 71.

The rewinder controller 73 controls drive of the rewinding motor 72. The rewinder controller 73 includes a CPU, a RAM, a ROM, a hard disk drive, and the like.

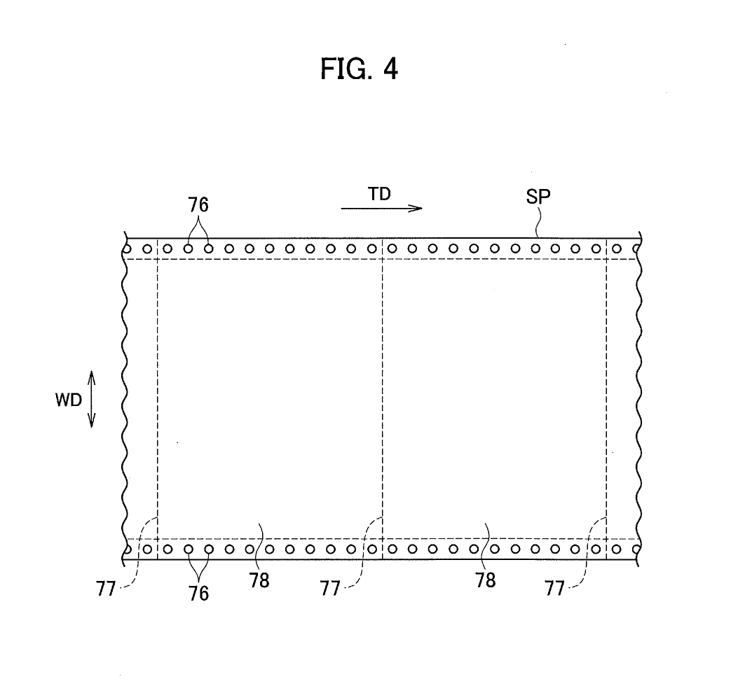

Next, the continuous sheet SP with holes is described with reference to FIG. 4.

As illustrated in FIG. 4, the continuous sheet SP with holes is formed in a long web shape. In the printing performed in the print system 1, the continuous sheet SP is conveyed with its longitudinal direction aligned in the conveyance direction.

The multiple holes 76 which are so-called sprocket holes are formed in the continuous sheet SP. The holes 76 are formed in one side end portion and the other side end portion of the continuous sheet SP in the width direction (short side direction) to be arranged at a predetermined pitch in the conveyance direction (longitudinal direction) of the continuous sheet SP.

Multiple perforations 77 parallel to the width direction are formed in the continuous sheet SP. The perforations 77 divide the continuous sheet SP in the conveyance direction into print regions 78 each having a predetermined length and corresponding to one page. In other words, the perforations 77 are formed at border positions of the print regions 78 for the respective pages. The continuous sheet SP can be separated into pages by using the perforations 77.

Next, description is given of operations performed by the print system 1 in printing in which the continuous sheet SP with holes is used as the print medium P.

When printing is to be performed on the continuous sheet SP, first, the continuous sheet SP is set in the print system 1. Specifically, the medium roll 16 which is the continuous sheet SP wound into a roll is held on the medium roll support shaft 11 of the unwinder 2. Then, the continuous sheet SP pulled out from the medium roll 16 is laid along the conveyance route in the printing apparatus 3 and a leading end portion of the continuous sheet SP is attached to the rewinding shaft 71 of the rewinder 4.

The user performs an operation of setting and inputting the aforementioned setting value Cfs for the front side and the aforementioned setting value Crs for the back side with the continuous sheet SP set in the print system 1.

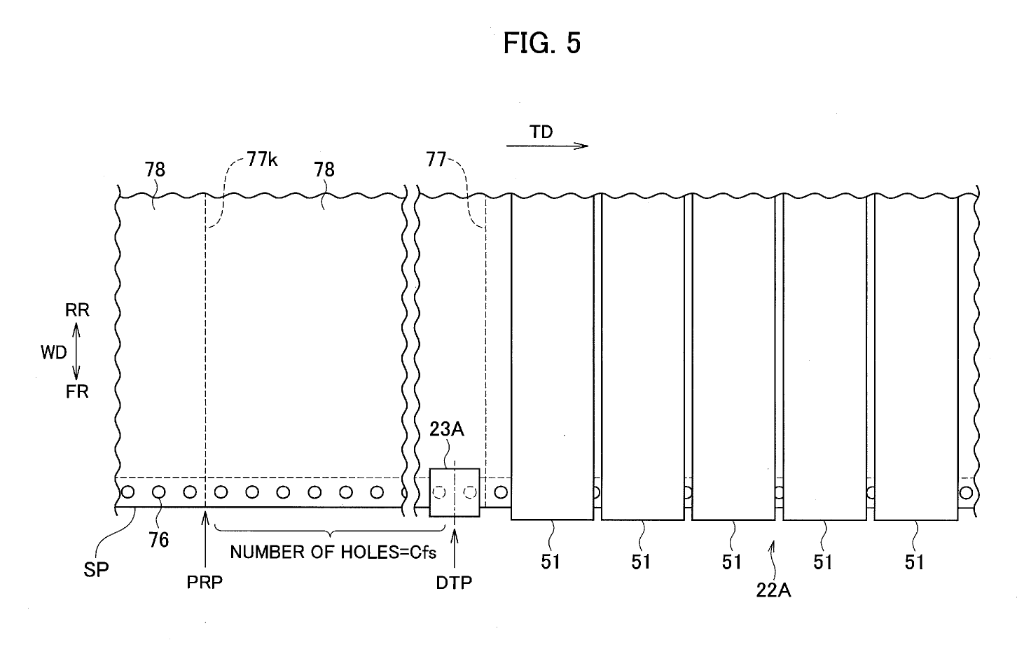

Specifically, as illustrated in FIG. 5, first, the user determines one of the perforations 77 upstream of the hole sensor 23A which the user wishes to set as the print start reference position, as a reference perforation 77k.

Next, the user sets and inputs the number of the holes 76 in the area from the hole sensor 23A to the print start reference position on the continuous sheet SP as the setting value Cfs for the front side by operating the input unit 62. Specifically, the user sets and inputs the number of the holes 76 in the area from a detection target position DTP of the hole sensor 23A to the reference perforation 77k, as the setting value Cfs for the front side.

Moreover, the user sets and inputs the number of the holes 76 in the area from the hole sensor 23B to the print start reference position on the continuous sheet SP as the setting value Crs for the back side by operating the input unit 62. Specifically, the user sets and inputs the number of the holes 76 in the area from a detection target position DTP of the hole sensor 23B to the reference perforation 77k, as the setting value Crs for the back side.

In the conveyor 21 of the printing apparatus 3, a scale (not illustrated) is installed along the conveyance route of the print medium P. The user can grasp the distance from the detection target position DTP of each of the hole sensors 23A, 23B to the reference perforation 77k on the conveyance route by using this scale. Then, the user can obtain the setting values Cfs, Crs by converting this distance into the number of the holes 76 based on the pitch of the holes 76.

When the user performs the operation of inputting the setting values Cfs, Crs on the input unit 62, the printing apparatus controller 25 sets the setting values Cfs, Crs.

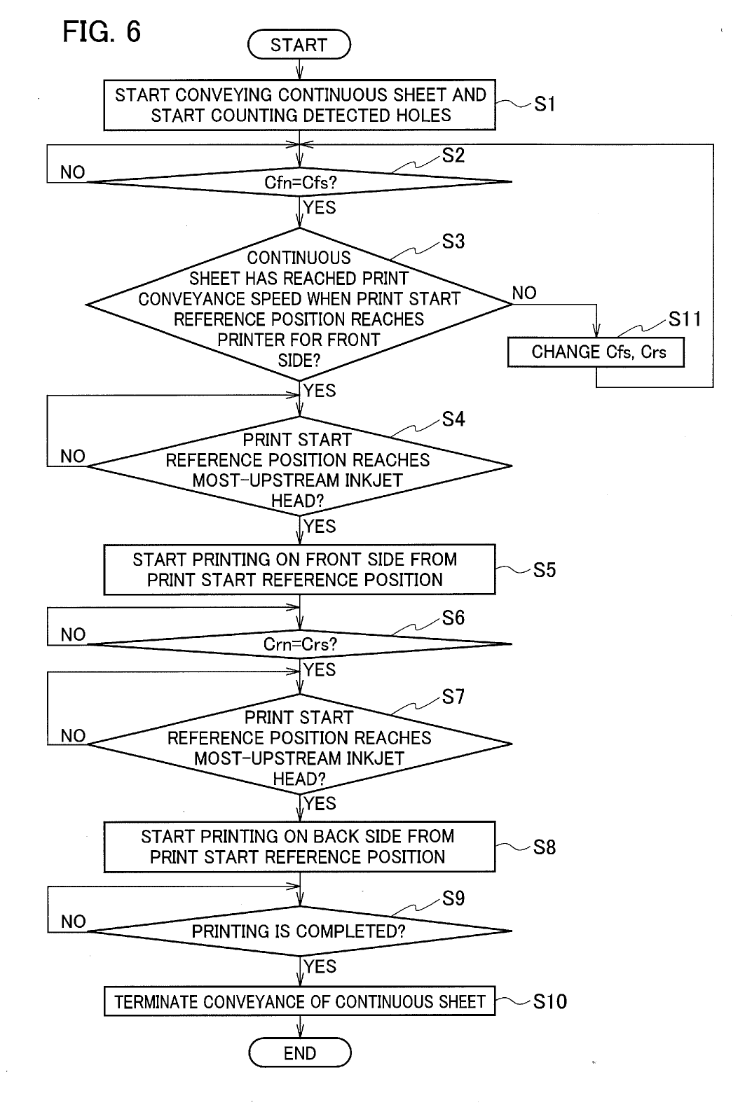

When the print job is inputted into the print system 1 after this setting, the print operation for the continuous sheet SP is started. FIG. 6 is a flowchart for explaining the print operation for the continuous sheet SP.

In step S1 of FIG. 6, the printing apparatus controller 25 starts the conveyance of the continuous sheet SP.

Specifically, the printing apparatus controller 25 starts drive of the conveyance rollers 43 by using the conveyance motor 44. Moreover, the printing apparatus controller 25 instructs the unwinder controller 13 and the rewinder controller 73 to start the conveyance of the continuous sheet SP. When the start of conveyance of the continuous sheet SP is instructed, the unwinder controller 13 starts drive of the brake 12 and the rewinder controller 73 starts drive of the rewinding shaft 71 by using the rewinding motor 72.

The conveyance of the continuous sheet SP from the unwinder 2 to the rewinder 4 is thereby started. The brake 12 of the unwinder 2 acts on the medium roll support shaft 11 and this causes the continuous sheet SP to be conveyed with tension applied to the continuous sheet SP between the medium roll 16 and the pair of conveyance rollers 43.

Moreover, in step S1, the printing apparatus controller 25 starts counting the holes 76 detected by each of the hole sensors 23A, 23B.

Then, in step S2, the printing apparatus controller 25 determines whether count value Cfn of the holes 76 detected by the hole sensor 23A from the start of conveyance of the continuous sheet SP has reached the setting value Cfs for the front side. Note that the count value Cfn reaches the setting value Cfs when the hole sensor 23A detects the hole 76 adjacent to and downstream of the reference perforation 77k. When the printing apparatus controller 25 determines that the count value Cfn has not reached the setting value Cfs yet (step S2: NO), the printing apparatus controller 25 repeats the step S2.

When the printing apparatus controller 25 determines that the count value Cfn has reached the setting value Cfs (step S2: YES), in step S3, the printing apparatus controller 25 determines whether the conveyance speed of the continuous sheet SP has reached predetermined print conveyance speed when the print start reference position PRP reaches the printer 22A for the front side. The moment when the print start reference position PRP reaches the printer 22A is the moment when the reference perforation 77k reaches the most-upstream inkjet head 56 in the printer 22A.

Note that the continuous sheet SP is accelerated at predetermined acceleration after the start of conveyance. Then, when the continuous sheet SP reaches the print conveyance speed, from this moment, the printing apparatus controller 25 controls the conveyance motor 44 such that the conveyance motor 44 conveys the continuous sheet SP at a constant speed which is the print conveyance speed. The print conveyance speed is speed set as the conveyance speed of the continuous sheet SP for performing printing by the printers 22.

In the printing apparatus 3, if the printers 22 perform printing during the acceleration of the continuous sheet SP, stretching of print images occurs. Accordingly, the printers 22 start the printing after the continuous sheet SP reaches the print conveyance speed.

The acceleration is constant until the continuous sheet SP reaches the print conveyance speed. Accordingly, it is possible to find out the conveyance amount of the continuous sheet SP from the moment when the count value Cfn reaches the setting value Cfs to the moment when the continuous sheet SP reaches the print conveyance speed, by using the time from the start of conveyance to the moment when the count value Cfn reaches the setting value Cfs. Moreover, the distance between the perforation 77 and the hole 76 adjacent to and downstream of the perforation 77 is a fixed value. The distance between the hole sensor 23A and the most-upstream inkjet head 56 in the printer 22A on the conveyance route is also a fixed value. Specifically, the conveyance amount of the continuous sheet SP from the moment when the count value Cfn reaches the setting value Cfs to the moment when the reference perforation 77k reaches the most-upstream head 56 in the printer 22A is a fixed value.

Accordingly, it is possible to determine whether the continuous sheet SP has reached the print conveyance speed when the print start reference position PRP reaches the printer 22A for the front side, by using the time from the start of conveyance to the moment when the count value Cfn reaches the setting value Cfs.

The printing apparatus controller 25 thus determines that the continuous sheet SP has reached the print conveyance speed when the print start reference position PRP reaches the printer 22A in the case where the count value Cfn reaches the setting value Cfs before a specified time calculated in advance elapses from the start of conveyance.

When the printing apparatus controller 25 determines that the continuous sheet SP has reached the print conveyance speed when the print start reference position PRP reaches the printer 22A (step S3: YES), in step S4, the printing apparatus controller 25 determines whether the print start reference position PRP has reached the most-upstream inkjet head 56 of the printer 22A. When the printing apparatus controller 25 determines that the print start reference position PRP has not reached the most-upstream inkjet head 56 in the printer 22A yet (step S4: NO), the printing apparatus controller 25 repeats step S4. When the printing apparatus controller 25 determines that the print start reference position PRP has reached the most-upstream inkjet head 56 in the printer 22A (step S4: YES), in step S5, the printing apparatus controller 25 starts printing on the front side of the continuous sheet SP from the print start reference position PRP.

The printing apparatus controller 25 starts the printing on the front side of the continuous sheet SP by the printer 22A based on the timing at which the count value Cfn reached the setting value Cfs.

Specifically, the printing apparatus controller 25 determines whether the print start reference position PRP has reached the most-upstream inkjet head 56 in the printer 22A based on the number of pulses outputted by the encoder 45 from the timing at which the count value Cfn reached the setting value Cfs (step S4). In this case, the printing apparatus controller 25 determines that the print start reference position PRP has reached the most-upstream inkjet head 56 in the printer 22A when the conveyance amount of the continuous sheet SP calculated from the number of pulses outputted by the encoder 45 from the timing at which the count value Cfn reached the setting value Cfs reaches the sum of the distance between the hole sensor 23A and the most-upstream inkjet head 56 in the printer 22A on the conveyance route and the distance between the perforation 77 and the hole 76 adjacent to and downstream of the perforation 77 (step S4: YES).

When the printing apparatus controller 25 determines that the print start reference position PRP has reached the most-upstream inkjet head 56 in the printer 22A as described above (step S4: YES), the printing apparatus controller 25 starts control of ink ejection by the inkjet head 56 based on the print job (step S5). Note that the user can set and adjust the start position of ink ejection on the front side of the continuous sheet SP as a distance from the print start reference position PRP (for example, in units of mm). This also applies to the back side.

Regarding each of the inkjet heads 56 other than the most-upstream inkjet head 56 in the printer 22A, when the print start reference position PRP reaches the inkjet head 56, the printing apparatus controller 25 similarly starts control of ink ejection by the inkjet head 56 based on the print job.

The printing from the print start reference position PRP (reference perforations 77k) on the front side of the continuous sheet SP is thus started and the printing on the front side for pages upstream of the print start reference position PRP is performed.

After starting the printing on the front side, in step S6, the printing apparatus controller 25 determines whether the count value Crn of the holes 76 detected by the hole sensor 23B from the start of conveyance of the continuous sheet SP has reached the setting value Crs for the back side. Note that the count value Crn reaches the setting value Crs when the hole sensor 23B detects the hole 76 adjacent to and downstream of the reference perforation 77k. When the printing apparatus controller 25 determines that the count value Crn has not reached the setting value Crs yet (step S6: NO), the printing apparatus controller 25 repeats step S6.

When the printing apparatus controller 25 determines that the count value Crn has reached the setting value Crs (step S6: YES), in step S7, the printing apparatus controller 25 determines whether the print start reference position PRP has reached the most-upstream inkjet head 56 in the printer 22B. When the printing apparatus controller 25 determines that the print start reference position PRP has not reached the most-upstream inkjet head 56 in the printer 22B yet (step S7: NO), the printing apparatus controller 25 repeats step S7. When the printing apparatus controller 25 determines that the print start reference position PRP has reached the most-upstream inkjet head 56 in the printer 22B (step S7: YES), in step S8, the printing apparatus controller 25 starts printing on the back side of the continuous sheet SP from the print start reference position PRP.

The printing apparatus controller 25 starts the printing on the back surface of the continuous sheet SP by the printer 22B based on timing at which the count value Crn reached the setting value Crs as in the aforementioned printing on the front side.

Specifically, the printing apparatus controller 25 determines whether the print start reference position PRP has reached the most-upstream inkjet head 56 in the printer 22B based on the number of pulses outputted by the encoder 45 from the timing at which the count value Crn reached the setting value Crs (step S7). In this case, the printing apparatus controller 25 determines that the print start reference position PRP has reached the most-upstream inkjet head 56 in the printer 22B when the conveyance amount of the continuous sheet SP calculated from the number of pulses outputted by the encoder 45 from the timing at which the count value Crn reached the setting value Crs reaches the sum of the distance between the hole sensor 23B and the most-upstream inkjet head 56 in the printer 22B on the conveyance route and the distance between the perforation 77 and the hole 76 adjacent to and downstream of the perforation 77 (step S7: YES).

When the printing apparatus controller 25 determines that the print start reference position PRP has reached the most-upstream inkjet head 56 in the printer 22B as described above (step S7: YES), the printing apparatus controller 25 starts control of ink ejection by the inkjet head 56 based on the print job (step S8). Note that, since the printer 22B is located downstream of the printer 22A, the continuous sheet SP has reached the print conveyance speed when the print start reference position PRP reaches the printer 22B.

Regarding each of the inkjet heads 56 other than the most-upstream inkjet head 56 in the printer 22B, when the print start reference position PRP reaches the inkjet head 56, the printing apparatus controller 25 similarly starts control of ink ejection by the inkjet head 56 based on the print job.

The printing from the print start reference position PRP (reference perforations 77k) on the back side of the continuous sheet SP is thus started and the printing on the back side for the pages upstream of the print start reference position PRP is performed.

After starting the printing on the back side, in step S9, the printing apparatus controller 25 determines whether the printing based on the print job is completed. When the printing apparatus controller 25 determines that the printing based on the print job is not completed (step S9: NO), the printing apparatus controller 25 repeats step S9.

When the printing apparatus controller 25 determines that the printing based on the print job is completed (step S9: YES), in step S10, the printing apparatus controller 25 terminates the conveyance of the continuous sheet SP. Specifically, the printing apparatus controller 25 stops the conveyance motor 44. Moreover, the printing apparatus controller 25 instructs the unwinder controller 13 and the rewinder controller 73 to terminate the conveyance of the continuous sheet SP. When the termination of the conveyance of the continuous sheet SP is instructed, the unwinder controller 13 stops the brake 12 and the rewinder controller 73 stops the rewinding motor 72. The series of print operations is thereby completed.

In step S3, when the printing apparatus controller 25 determines that the continuous sheet SP has not reached the print conveyance speed when the print start reference position PRP reaches the printer 22A (step S3: NO), in step S11, the printing apparatus controller 25 changes the setting values Cfs, Crs.

Specifically, the printing apparatus controller 25 adds the number of the holes 76 in each print region 78 to each of the setting values Cfs, Crs to set new setting values Cfs, Crs. In this case, the number of the holes 76 in each print region 78 is inputted by, for example, a user operation. After changing the setting values Cfs, Crs, the printing apparatus controller 25 returns to step S2 and repeats the subsequent processes.

Changing the setting values Cfs, Crs as described above causes the print start reference position PRP (reference perforation 77k) to be shifted upstream by one page. Accordingly, the timing of print start is pushed back. This avoids the case where the print images are stretched due to printing started without the continuous sheet SP reaching the print conveyance speed.

As described above, when the printing apparatus 3 performs printing on the continuous sheet SP, the printing apparatus controller 25 sets the number of the holes 76 in the area from the hole sensor 23A to the print start reference position PRP on the continuous sheet SP at the start of conveyance of the continuous sheet SP as the setting value Cfs for the front side. Moreover, the printing apparatus controller 25 sets the number of the holes 76 in the area from the hole sensor 23B to the print start reference position PRP on the continuous sheet SP at the start of conveyance of the continuous sheet SP as the setting value Crs for the back side.

Then, the printing apparatus controller 25 starts the printing on the front side by the printer 22A based on the timing at which the count value Cfn of the holes 76 detected by the hole sensor 23A from the start of conveyance of the continuous sheet SP reached the setting value Cfs for the front side. Moreover, the printing apparatus controller 25 starts the printing on the back side by the printer 22B based on the timing at which the count value Crn of the holes 76 detected by the hole sensor 23B from the start of conveyance of the continuous sheet SP reached the setting value Crs for the back side.

The printing apparatus controller 25 can thus start the printing while grasping the print start reference position PRP on the conveyed continuous sheet SP by counting the holes 76 detected by the hole sensors 23. Accordingly, the printing apparatus 3 can start the printing on the continuous sheet SP with holes from a desired position.

Moreover, when the printing apparatus controller 25 determines that the conveyance speed of the continuous sheet SP has not reached the print conveyance speed when the print start reference position PRP reaches the printer 22A, the printing apparatus controller 25 changes the setting values Cfs, Crs by adding the number of the holes 76 in each print region 78 to each of the setting values Cfs, Crs and pushes back the timing of print start. The printing performed with the position of the perforation 77 set as the print start reference position PRP is thereby not started during the acceleration in which the continuous sheet SP has not reached the print conveyance speed yet. As a result, it is possible to start the printing with the position of the perforation 77 set as the print start reference position PRP while avoiding stretching of print images.

In the aforementioned embodiment, description is given of the case where the web print medium with holes is the continuous sheet SP in which the perforations 77 are formed. However, the web print medium with holes may be a medium with no perforations dividing the print regions for the respective pages. For example, the web print medium with holes may include marks such as recesses and lines, instead of the perforations, as objects dividing the print regions for the respective pages (objects on which the user wants to avoid printing, objects which affect printing results when printing is performed thereon). Also in this case, it is only necessary to determine the print start reference position PRP desired by the user and set the number of the holes in the area from the hole sensor to the print start reference position PRP on the print medium at the start of conveyance as the setting value used to determine the timing of print start.

Moreover, although the configuration in which the unwinder and the rewinder are connected to the printing apparatus as separate apparatuses is described in the aforementioned embodiment, the configuration may be such that the unwinder and the rewinder are incorporated in the printing apparatus.

The embodiments of the disclosure have, for example, the following configurations.

A printing apparatus includes: a conveyor configured to convey a web print medium with holes arranged at a predetermined pitch in a conveyance direction; a printer configured to perform printing on the web print medium conveyed by the conveyor; a detector configured to detect the holes; and a controller. The controller is configured to drive the printer to start printing on the web print medium based on a timing at which a count value of the holes detected by the detector from start of conveyance of the web print medium by the conveyor reaches a setting value of a number of the holes located from the detector to a print start reference position on the web print medium at the start of conveyance of the web print medium by the conveyor.

The web print medium may be divided into print regions each with a predetermined length in the conveyance direction, and the print start reference position may be located at one of boarder positions each provided between the print regions adjacent to each other. The controller may be configured to: determine whether the count value has reached the setting value; upon determining that the count value has reached the setting value, determine whether a conveyance speed of the web print medium has reached a predetermined print conveyance speed at a timing at which the print start reference position reaches the printer; and upon determining that the conveyance speed of the web print medium has not reached the predetermined print conveyance speed at the timing at which the print start reference position reaches the printer, change the setting value by adding a number of the holes in each of the print regions to the setting value and drive the printer to start the printing on the web print medium based on a timing at which the count value reaches the changed setting value.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A printing apparatus comprising:
a conveyor configured to convey a web print medium with holes arranged at a predetermined pitch in a conveyance direction;
a printer configured to perform printing on the web print medium conveyed by the conveyor;
a detector configured to detect the holes; and
a controller configured to drive the printer to start printing on the web print medium based on a timing at which a count value of the holes detected by the detector from start of conveyance of the web print medium by the conveyor reaches a setting value of a number of the holes located from the detector to a print start reference position on the web print medium at the start of conveyance of the web print medium by the conveyor.

2. The printing apparatus according to claim 1, wherein
the web print medium is divided into print regions each with a predetermined length in the conveyance direction,
the print start reference position is located at one of boarder positions each provided between the print regions adjacent to each other,
the controller is configured to
determine whether the count value has reached the setting value,
upon determining that the count value has reached the setting value, determine whether a conveyance speed of the web print medium has reached a predetermined print conveyance speed at a timing at which the print start reference position reaches the printer, and
upon determining that the conveyance speed of the web print medium has not reached the predetermined print conveyance speed at the timing at which the print start reference position reaches the printer, change the setting value by adding a number of the holes in each of the print regions to the setting value and drive the printer to start the printing on the web print medium based on a timing at which the count value reaches the changed setting value.
